(19) United States
(12) Patent Application Publication
(10) Pub. No.: US 2015/0119236 A1
(43) Pub. Date: Apr. 30, 2015

(54) OXIDATION CATALYST PREPARATION

(71) Applicant: Rohm and Haas Company, Philadelphia, PA (US)

(72) Inventor: Leonard E. Bogan, JR., Lansdale, PA (US)

(21) Appl. No.: 14/398,818

(22) PCT Filed: Apr. 19, 2013
(86) PCT No.: PCT/US2013/037320

§ 371 Date: Nov. 4, 2014

Related U.S. Application Data
(60) Provisional application No. 61/656,785, filed on Jun. 7, 2012.

(51) Int. Cl. B01J 27/057

(52) U.S. Cl. CPC B01J 27/0576
USPC 502/215

(57) ABSTRACT

A method for producing a catalyst by contacting a starting mixed metal oxide catalyst with an aqueous solution comprising oxalic acid and a metal oxide precursor to form a post-treated mixed metal oxide catalyst.

### CROSS-REFERENCE TO RELATED APPLICATIONS

This application claims priority from provisional application Ser. No. 61656,785, filed Jun. 7, 2012, which is incorporated herein by reference in its entirety.

### BACKGROUND OF THE INVENTION

The invention relates to a process for the preparation of a catalyst that can be employed in the production of acrylic acid from propane.

The preparation of a MoVTeNb-oxide catalyst and its use for ammoxidation of propane to acrylonitrile was disclosed by Mitsubishi Kasei Corporation in U.S. Pat. No. 5,049,692. About five years later, the same company disclosed the use of this catalyst in U.S. Pat. No. 5,380,933 for oxidation of propane to acrylic acid (AA). Since that time, many companies have filed applications for improved preparations of the catalyst, and many articles have been published on this topic in the open literature. Preparations generally consist of mixing soluble complexes of the metals in water, isolating a solid, either by drying or by treating hydrothermally, and calcining in an inert (oxygen-free) atmosphere at a temperature of about 600° C.

U.S. Pat. No. 7,875,571 discloses treatment of a calcined MoVTeNb-oxide catalyst with a solution containing 0-3% of certain metal ions in water, in conjunction with separate steps of calcination, grinding, and treatment with an oxalic acid solution.

It would be desirable to have a simpler, less expensive, preparation process for such catalysts, while obtaining equivalent or better results when using a catalyst prepared by the process. A simpler process would be less prone to error.

### SUMMARY OF THE INVENTION

The invention includes such a method for producing a post-treated catalyst comprising the steps of: (a) providing a starting mixed metal oxide catalyst having the empirical formula AₐV_{b}N_{c}X_{d}ZₑO_{f} wherein A is at least one element selected from the group consisting of Mo and W, N is at least one element selected from the group consisting of Te and Sb, X is at least one element selected from the group consisting of Nb, Ta, Ti, Al, Zr, Cr, Mn, Fe, Ru, Co, Rh, Ni, Pt, Sb, Bi, B, In, As, Ge, Sn, Hf, Pb, P, Pm, Eu, Gd, Dy, Ho, Er, Tm, Yb and Lu, and Z is at least one element selected from the group consisting of Zn, Ga, Ir, Sm, Pd, Au, Ag, Cu, Sc, Y, Pr, Nd and Tb; and wherein, when a=1, b=0.01 to 1.0, c=0.01 to 1.0, d=0.01 to 1.0, e=0 to 0.1 and f is dependent on the oxidation state of the other elements; and (b) contacting the starting mixed metal oxide catalyst with an aqueous solution comprising oxalic acid and a metal oxide precursor, wherein the precursor contains 0.01 to 3 weight parts Nb based on 100 weight parts of the starting mixed metal oxide catalyst, to form a post-treated mixed metal oxide catalyst.

Surprisingly, the post-treated catalyst may perform as well as, or better than a catalyst prepared by a more complex method of preparation.

### DETAILED DESCRIPTION OF THE INVENTION

The process of the invention prepares a post-treated catalyst from starting materials comprising a starting mixed-metal oxide (“SMMO”) catalyst and an aqueous solution comprising oxalic acid and a metal oxide precursor.

As used herein, “a,” “an,” “the,” “at least one,” and “one or more” are used interchangeably. The terms “comprises,” “includes,” and variations thereof do not have a limiting meaning where these terms appear in the description and claims. Thus, for example, an aqueous composition that includes particles of “a” hydrophobic polymer can be interpreted to mean that the composition includes particles of “one or more” hydrophobic polymers.

Also herein, the recitations of numerical ranges by endpoints include all numbers subsumed in that range (e.g., 1 to 5 includes 1, 1.5, 2, 2.75, 3, 3.80, 4, 5, etc.). Also herein, the recitations of numerical ranges and/or numerical values, including such recitations in the claims, can be read to include the term “about.” In such instances the term “about” refers to numerical ranges and/or numerical values that are substantially the same as those recited herein.

For the purposes of the invention, it is to be understood, consistent with what one of ordinary skill in the art would understand, that a numerical range is intended to include and support all possible subranges that are included in that range. For example, the range from 1 to 100 is intended to convey from 1.01 to 100, from 1 to 99.99, from 1.01 to 99.99, from 40 to 60, from 1 to 55, etc.

Unless stated to the contrary, or implicit from the context, all parts and percentages are based on weight and all test methods are current as of the filing date of this application. For purposes of United States patent practice, the contents of any referenced patent, patent application or publication are incorporated by reference in their entirety (or its equivalent U.S. version is so incorporated by reference) especially with respect to the disclosure of definitions (to the extent not inconsistent with any definitions specifically provided in this disclosure) and general knowledge in the art.

The general formula for the SMMO catalyst is AₐV_{b}N_{c}X_{d}ZₑO_{f} where the symbols are as defined above. In one embodiment, the SMMO is promoted, i.e. Z is present, preferably with a value of e from 0.001 to 0.1. Promoted SMMO catalysts are described, e.g., in U.S. Pat. Nos. 6,825,380; 6,790,988; 6,700,015; 6,504,053 and 6,407,280. In another embodiment, Z is absent (e=0).

Preferably, for the SMMO, when a=1, b=0.1 to 0.5, c=0.05 to 0.5, d=0.01 to 0.5 and e=0.001 to 0.02. More preferably, when a=1, b=0.15 to 0.45, c=0.05 to 0.45, d=0.05 to 0.2 and e=0.005 to 0.015. However, in an alternative embodiment, when a=1 and e=0, b=0.01 to 1.0, c=0.01 to 1.0 and d=0.01 to 1.0; preferably, when a=1 and e=0, b=0.1 to 0.5, c=0.05 to 0.5 and d=0.01 to 0.5; more preferably, when a=1 and e=0, b=0.15 to 0.45, c=0.05 to 0.45 and d=0.05 to 0.2. Moreover, in a further alternative embodiment, e=0.005 to 0.1; more preferably, e=0.01 to 0.05. The value of f, i.e. the amount of oxygen present, is dependent on the oxidation state of the other elements in the catalyst. However, f is typically in the range of from 3 to 4.7. Preferably, A is Mo. Preferably, N is Te. Preferably, X is Nb or Ta; and most preferably, X is Nb. In one preferred embodiment of the invention, the catalyst is MoₐV_{b}Te_{c}Nb_{d}ZₑO_{f}. Preferably, Z is Pd. In another embodiment of the invention, the catalyst is MoₐV_{b}Te_{c}Nb_{d}O_{f} (e=0).

The SMMO catalyst is formed according to methods well known to those skilled in the art as described, e.g., in U.S. Pat. Nos. 6,825,380; 6,790,988; 6,700,015; 6,504,053 and 6,407,280.

The SMMO advantageously is ground before the treatment step of the invention. Preferably, the surface area after grinding is from 5 to 30 m²g. Many devices for grinding are well known to those skilled in the art. The choice of grinding apparatus is not particularly critical. Examples of suitable types of grinding apparatus include, e.g., a freezer/mill, a ball mill, a mortar and pestle, and a jet mill.

In the present invention, the SMMO is contacted with water comprising oxalic acid and a metal oxide precursor to produce a post-treated MMO catalyst. The water comprising oxalic acid and a metal oxide precursor advantageously is an aqueous solution of oxalic acid and a metal oxide precursor.

A metal oxide precursor is a metal-containing substance, e.g., a metal complex and/or a metal salt, that can be oxidized or decomposed to form a metal oxide, e.g., by calcination, where the metal comprises niobium. Combinations of niobium and other metals, e.g., Te, Mo, and/or V may be present in the metal oxide precursor. Examples of metal oxide precursors include, for example, ammonium niobium oxalate, which is preferred, niobium tartrate, and niobium citrate. Advantageously, from 0.01 to 3 weight parts of metal of the metal oxide precursor, based on 100 weight parts of the starting mixed metal oxide catalyst is employed. Preferably, the amount of metal is from 0.135 parts to 0.62 parts, and more preferably is from 0.20 parts to 0.60 parts.

Advantageously, the amount of oxalic acid in the solution employed is from 0.1 to 30 weight percent, based on the weight of the solution. Preferably, the amount of oxalic acid is from 0.5% to 10%, and more preferably is from 1% to 2%. The oxalic acid can be supplied in hydrated form, such as oxalic acid dihydrate.

The SMMO, oxalic acid and metal oxide precursor advantageously are in contact for at least 6 minutes, and preferably at least 60 minutes. Advantageously, the mixture is heated for no more than 72 hours, preferably for no more than 24 hours and even more preferably for no more than 6 hours. The contacting temperature advantageously is at least room temperature. Preferably, the temperature is at least 20° C., is more preferably at least 40° C., and even more preferably is at least 50° C. In one embodiment of the invention, the contacting is conducted at reflux temperature, it being understood that in a closed or pressurized system, reflux temperature could be higher than 100° C.

The post-treated MMO catalyst can be employed to oxidize propane to acrylic acid.

### SPECIFIC EMBODIMENTS OF THE INVENTION

The following examples are given to illustrate the invention and should not be construed as limiting its scope. All parts and percentages are by weight unless otherwise indicated.

### Comparative Experiment 1

### Preparation of Comparative MMO Catalyst (Not An Embodiment of the Invention)

A catalyst is prepared as described in Comparative Example 1 of U.S. Pat. No. 7,875,571. The unground catalyst (10.0 g) is stirred in a solution of 0.25 g ammonium niobium oxalate in 25 g water for five hours, then dried on a rotary evaporator (50° C., 20 mm Hg) and further dried overnight in a vacuum oven (25° C., 20 mm Hg). The dried powder is re-calcined in a tube furnace under nitrogen (5° C/min to 300° C., 2° C/min to 500° C., hold two hours) to yield 9.8 g black solid. This is ground in two portions with a Freezer/Mill (Model 6750 from Spex CertiPrep) for 2×4 min., stirred for five hours in 50 g of a 2% solution of oxalic acid dihydrate in water, then is filtered, is washed with water, and dried (20 mm Hg, room temperature) overnight. The resulting black powder is pressed and sieved to 14-20 mesh (1.40-0.85 mm) to give granules of comparative catalyst. The yield of acrylic acid at 85% oxygen conversion is reported in Table 1.

### Preparation 1

### Preparation of Starting Mixed Metal Oxide Catalyst

A solution is prepared by adding 35.7 g ammonium heptamolybdate, 6.85 g ammonium metavanadate, and 3.72 g telluric acid to 200 g water at 70° C. with stirring for 20 min. To the solution, 7.8 g concentrated nitric acid is added, and the resulting mixture is stirred for a few minutes. Then, a solution of 15.4 g ammonium niobium oxalate and 4.08 g oxalic acid in 200 g water is added, is stirred five minutes, and then water is evaporated using a rotavap. The resulting solids are dried overnight at room temp. under vacuum to yield an orange solid. The orange solids are calcined (10° C/min to 275° C., hold 1 hr, switch to N₂, 2° C/min to 625° C., hold 2 hrs) to yield about 40 g of a black solid. The black solid is ground using a Freezer/Mill Model 6750 from Spex CertiPrep to give a material having a BET surface area of about 12 m²g. This procedure is repeated eight times and the products are combined and mixed. The mixed black solids are designated Catalyst A.

### Example 1

Catalyst A (10.0 g) is heated in a solution of 25 g 4% aq. oxalic acid, 25 g water, and 0.36 g 10% aq. ammonium niobium oxalate (from H. C. Starck) for 3 hr at reflux, is filtered, washed, and dried (20 mm Hg, room temp) overnight, and is then pressed and sieved to 14-20 mesh (1.40 to 0.85 mm) to give the granules of the post-treated catalyst.

### Examples 2-7

The procedure of Example 1 is repeated, with exceptions as shown in Table 1.

### Examples 8-14

### Catalyst Evaluation

Post-treated catalyst granules (5.0 g) are diluted 1:1 with comparable sized silicon carbide chips and packed into a ½-inch diameter stainless steel tube. The tube is heated in an electric furnace and fed with propane:air:steam 7:71:22 by volume. The effluent of the reactor is analyzed by gas chromatography to determine the propane conversion and the yield of acrylic acid. The results are shown in Table 1. Carbon accountabilities are 98-102%. Yields of acrylic acid at 85% oxygen conversion are reported.

TABLE 1
Reagent amounts used in examples.

| | | | | | OA | | |
|---|---|---|---|---|---|---|---|
| | | | | | in | | AA |
| | 2% OA | 4% OA | 10% ANO | water | soln | Nb | yield |
| | (g) | (g) | (g) | (g) | (%) | (**) | (%) |
| Comp. Ex. 1 | | | | | 2 | 0.518 | 57.2 |
| Ex. 1 | | 25 | 0.36 | 24.64 | 2 | 0.075 | 57.5 |
| Ex. 2 | | 25 | 0.72 | 24.28 | 2 | 0.149 | 58.3 |
| Ex. 3 | | 25 | 1.45 | 23.55 | 2 | 0.300 | 58.1 |
| Ex. 4 | 50 | | 3.75 | 3.75 | 1.74 | 0.777 | 58.2 |
| Ex. 5 | 50 | | 7.5 | 0 | 1.74 | 1.554 | 57.3 |
| Ex. 6 | 25 | | 7.5 | 17.5 | 1 | 1.554 | 57.0 |
| Ex. 7 | | 25 | 14.9 | 10.1 | 2 | 3.087 | 56.5 |

(**) weight parts of Nb based on 100 weight parts of the starting mixed metal oxide catalyst.
OA = oxalic acid,
ANO = ammonium niobium oxalate, and
AA = acrylic acid.

Comparative Experiment 1 uses the catalyst preparation method taught in U.S. Pat. No. 7,875,571. Surprisingly, the method of this invention gives a catalyst that performs just as well as the comparative post-treated catalyst that is prepared using separate treatments with Nb and oxalic acid plus a calcination after treatment with Nb. Since the '571 patent teaches that its method gives poorer performance when the calcination step is omitted or carried out at too low a temperature (e.g. 300° C.), it is unexpected that combining the Nb and oxalic acid treatments and eliminating the calcination result in a catalyst with excellent performance.

1. A method for producing a post-treated catalyst comprising the steps of: (a) providing a starting mixed metal oxide catalyst having the empirical formula AₐV_{b}N_{c}X_{d}ZₑO_{f} wherein A is at least one element selected from the group consisting of Mo and W, N is at least one element selected from the group consisting of Te and Sb, X is at least one element selected from the group consisting of Nb, Ta, Ti, Al, Zr, Cr, Mn, Fe, Ru, Co, Rh, Ni, Pt, Sb, Bi, B, In, As, Ge, Sn, Hf, Pb, P, Pm, Eu, Gd, Dy, Ho, Er, Tm, Yb and Lu, and Z is at least one element selected from the group consisting of Zn, Ga, Ir, Sm, Pd, Au, Ag, Cu, Sc, Y, Pr, Nd and Tb; and wherein, when a=1, b=0.01 to 1.0, c=0.01 to 1.0, d=0.01 to 1.0, e=0 to 0.1 and f is dependent on the oxidation state of the other elements; and (b) contacting the starting mixed metal oxide catalyst with an aqueous solution comprising oxalic acid and a metal oxide precursor, wherein the precursor contains 0.01 to 3 weight parts Nb based on 100 weight parts of the starting mixed metal oxide catalyst, to form a post-treated mixed metal oxide catalyst.

2. The method of claim 1 in which the amount of Nb in the metal oxide precursor is from 0.135 to 0.62 weight parts.

3. The method of claim 2 in which the amount of Nb in the metal oxide precursor is from 0.20 to 0.60 weight parts.

4. The method of claim 1 wherein the metal oxide precursor comprises at least one of ammonium niobium oxalate, niobium tartrate, and niobium citrate.

5. The method of claim 1 wherein the metal oxide precursor comprises ammonium niobium oxalate.

6. The method of claim 1 wherein step b) does not include calcining.

7. The method of claim 1 wherein the post-treated catalyst is not calcined.

8. The method of claim 1 wherein the amount of oxalic acid is from 0.1 to 30 weight percent, based on the weight of the solution.

9. The method of claim 1 wherein the amount of oxalic acid is from 0.5% to 10%.

10. The method of claim 1 wherein the amount of oxalic acid is from 1% to 2%.
